(19) United States
(12) Patent Application Publication
(10) Pub. No.: US 2025/0051045 A1
(43) Pub. Date: Feb. 13, 2025

(54) AUTONOMOUS ROBOT POWER MANAGEMENT SYSTEM

(71) Applicant: International Business Machines Corporation, Armonk, NY (US)

(72) Inventors: Sarbajit K. Rakshit, Kolkata (IN); Manikandan Padmanaban, Chennai (IN); Jagabondhu Hazra, Bangalore (IN)

(73) Assignee: International Business Machines Corporation, Armonk, NY (US)

(21) Appl. No.: 18/233,102

(22) Filed: Aug. 11, 2023

(51) Int. Cl. B64U 50/34; B64U 10/40; B64U 101/30; G05D 1/644; G05D 1/656; G05D 105/00; G05D 109/20; G05D 111/10

(52) U.S. Cl. CPC B64U 50/34; B64U 10/40; G05D 1/644; G05D 1/656; B64U 2101/30; B64U 2201/10; G05D 2105/57; G05D 2109/265; G05D 2111/10

(57) ABSTRACT

An embodiment establishes a potential energy source database based at least in part on sensor data received from a satellite, wherein the potential energy source database comprises coordinate data representative of a plurality of potential energy source locations. The embodiment instructs a robot to travel to a potential energy source location of the plurality of potential energy source locations. The embodiment scans the potential energy source location for a potential energy source. The embodiment detects the potential energy source in the potential energy source location. The embodiment evaluates whether the potential energy source meets a predetermined suitability criteria. The embodiment classifies the potential energy source as a suitable energy source. The embodiment instructs the robot to insert a pair of electrodes into the suitable energy source to generate an electrical current to charge a battery of the robot.

### BACKGROUND

The present invention relates generally to robotics. More particularly, the present invention relates to a method, system, and computer program for autonomous power management of a robot.

Robotics technology has evolved significantly over the past few years. Robotic systems (also referred to simply as “robots”) currently exist that are designed to perform a wide range various tasks in various applications. Some robots today utilize human input to perform a desired task, whereas other robots are fully autonomous and are configured to perform a desired task without any human input.

An unmanned aerial vehicles (“UAV”) is type of aircraft that may be configured to operate without a human pilot onboard. Rather than using an onboard human pilot, a UAV may be controlled remotely by a human operator using a remote controlling device and/or a ground control station. The operator can control the UAV's flight path, altitude, and other functionalities. A UAV may also be configured to operate autonomously via an onboard computer system. A UAV equipped with an onboard computer system and one or more sensors enables an operator to program instructions that enable the UAV to fly autonomously without constant human intervention. An autonomous UAV may follow pre-programmed flight paths and/or make decisions based on real-time data collected from the UAV's surroundings.

Artificial intelligence (AI) technology has also evolved significantly over the past few years. Modern AI systems are achieving human level performance on cognitive tasks like converting speech to text, recognizing objects and images, or translating between different languages. This evolution holds promise for new and improved applications in many industries, including robotics technology.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

### SUMMARY

The illustrative embodiments provide for autonomous robot power management. An embodiment includes establishing a potential energy source database based at least in part on sensor data received from a satellite, wherein the potential energy source database comprises coordinate data representative of a plurality of potential energy source locations. The embodiment also includes instructing a robot to travel to a potential energy source location of the plurality of potential energy source locations. The embodiment also includes scanning the potential energy source location for a potential energy source. The embodiment also includes detecting the potential energy source in the potential energy source location. The embodiment evaluating whether the potential energy source meets a predetermined suitability criteria. The embodiment also includes classifying the potential energy source as a suitable energy source. The embodiment also includes instructing the robot to insert a pair of electrodes into the suitable energy source to generate an electrical current to charge a battery of the robot. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example processing environment of an autonomous robot power management system in accordance with an illustrative embodiment;

FIG. 3 depicts a block diagram of an example energy management module in accordance with an illustrative embodiment;

FIG. 4 depicts a block diagram of an example process for autonomous robot power management in accordance with an illustrative embodiment;

FIG. 5A depicts a block diagram of an example robotic system in accordance with an illustrative embodiment;

FIG. 5B depicts a block diagram of an example battery management system in accordance with an illustrative embodiment;

FIG. 6 depicts a block diagram of an example process for training a machine learning model in accordance with an illustrative embodiment;

FIG. 7 depicts a block diagram of an example model training module in accordance with an illustrative embodiment;

FIG. 8A depicts a graph diagram of an example route schedule in accordance with an illustrative embodiment;

FIG. 8B depicts a framework for providing an example optimized route schedule in accordance with an illustrative embodiment; and

FIG. 9 depicts a flowchart of an example process for autonomous robot power management in accordance with an illustrative embodiment.

### DETAILED DESCRIPTION

Advancements in robotics technology include the development of insect-scale robots. These insect-scale robots are often referred to as “robotic bugs” or “microbots.” Microbots have developed for a number of different applications, including but not limited to, medicine, manufacturing, environmental monitoring, climate monitoring, weather monitoring, exploration, search and rescue, assisted agriculture, crop pollination, research, and more.

Microbots are often constructed utilizing specialized materials and technologies, including but not limited to, microelectromechanical systems (MEMS), nanotechnology, and/or bioengineering. Further, microbots may be powered by various means, including but not limited to, onboard batteries, external power sources, and/or by harnessing energy from a surrounding environment. Compared to larger scale robots, microbots may be designed according to additional constraints based on their size. Accordingly, due to their relatively small size, microbots often face challenges related to power supply, control mechanisms, and/or communication. In particular, maintaining sufficient power to perform tasks continues to be a problem associated with microbots.

Despite the advancements made in robotics technology and in particular to microbots, currently existing microbots are limited in the amount of tasks microbots are able to perform and/or accomplish due to the limited capacity of a microbot's power supply. The present disclosure addresses the deficiencies described above by providing a process (as well as a system, method, machine read-able medium, etc.) that locates a potential energy source for recharging a microbot battery and recharges the microbot battery using the potential energy source located. Disclosed embodiments combine satellite image data collection and route-planning optimization, and leverage one or more machine learning models to locate a potential energy source locations and identify a suitable energy source within the potential energy source location.

An embodiment includes a microbot approximately half the size of a paperclip that weighs approximately less than one-tenth of a gram. Further, an embodiment includes a microbot that is designed to fly using artificial muscle constructed from a specialized material that contacts when a voltage is applied to the material. In an embodiment, the microbot includes an autonomous micro aerial vehicle (“MAV”) capable of self-contained, self-directed flight. A consideration involving the design of the autonomous MAV includes the amount of power that may be stored on the battery of an MAV, due to the size of the onboard battery. Depending on the task to be performed and/or the length/duration of a flight, the MAV may need to generate and store additional power, or otherwise return to a dedicated recharging location. In an embodiment, the MAV is configured to generate electricity from an electrolyte source existing in a surrounding environment. In some such embodiments, the electrolyte source may include, but is not limited to, a fruit, such as a citrus fruit, a salt-rich soil environment, and/or salt water. Accordingly, in a particular embodiment, the MAV may generate electricity from citric acid within the fruit, by inserting a pair of electrodes (i.e., cathode and anode) into the fruit, to cause an electrochemical reaction to generate an electric current, and drive the electric current generated through a wire to charge the onboard battery of the MAV.

The illustrative embodiments provide for autonomous robot battery management. Embodiments disclosed herein describe the robot as a microbot such as a MAV, and in some particular embodiments as a robotic bee; however, use of these examples is not intended to be limiting, but is instead used for descriptive purposes only. Instead, the robot can include elements of one or more of a types of robots, including other robot bugs, such as a robotic fly, a robotic butterfly, a robotic cockroach, a robotic ant, etc.

As used throughout the present disclosure, the term “robot” refers to a programmable machine that may be programmed to perform one or more tasks. In general, a robot may include a processor, a memory, and a set of instructions stored on the memory that when executed by the processor cause the robot to perform a task. A robot includes a human-controlled robot that may be configured to receive human input to perform a task, as well as an autonomous robot that may be configured to perform one or more tasks without any human input. Further, the term “microbot” refers to a miniature sized robot compared to regular sized robot. A microbot may include some or all of the components and/or features of a robot, except on a smaller-scale. In general, a microrobot is larger than a nanorobot, which is created on the nanoscale. Microrobots are usually visible, whereas some nanobots are not immediately visible to the human eye. A microrobot generally refers to a robot with a size in the order of micrometers to millimeters. Examples of microbots may include, but are not limited to, insect sized robots, such as for example, a robotic bee. As a nonlimiting example, a robotic bee may be approximately 14 milometers in size, and weigh approximately one tenth of a gram or less.

As used throughout the present disclosure, the term “multispectral imaging” refers to a process for capturing image data within specific wavelength ranges across the electromagnetic spectrum. The wavelengths may be separated by filters or detected with the use of instruments that are sensitive to particular wavelengths, including light from frequencies beyond the visible light range, i.e. infrared and ultra-violet. Multispectral imaging enables extraction of additional information the human eye may be unable to capture with human eye's visible receptors for red, green and blue. Multispectral imaging technology may be used for a variety of applications, including but not limited to, mapping details of the Earth related to coastal boundaries, vegetation, and landforms. Further, multispectral imaging measures light in a number discrete spectral bands, typically 3 to 15 spectral bands.

As used throughout the present disclosure, the term “hyperspectral imaging” refers to a type of spectral imaging that may utilize a number of contiguous spectral bands, and accordingly may utilize hundreds of contiguous spectral bands. Hyperspectral imaging includes obtaining the spectrum for each pixel in the image of a scene, with the purpose of finding objects, identifying materials, and/or detecting processes.

Multispectral and hyperspectral imaging are both imaging techniques used in remote sensing and various applications to capture and analyze data from different parts of the electromagnetic spectrum. The relationship between multispectral and hyperspectral imaging may be understood as follows: multispectral imaging includes capturing data in a limited number of discrete spectral bands, while hyperspectral imaging captures data in numerous narrower and contiguous spectral bands. Compared to multispectral imaging, hyperspectral imaging may provide a more detailed and precise analysis of materials and substances present in an observed scene.

As used throughout the present disclosure, the term “work order schedule” refers to a plan or timetable that outlines the sequence and timing of tasks or jobs assigned to a robot. Accordingly, the work order schedule specifies the order in which one or more robots should perform certain activities, such as carrying out specific tasks, moving to different locations, and/or interacting with other elements within an environment. The work order schedule may enable coordination and optimization of the activities of multiple robots to achieve efficient and effective completion of tasks within a given timeframe.

As used throughout the present disclosure, the term “state of charge” (or simply “SOC”) refers to the amount of electric charge remaining in a battery at a given time. SOC may typically be expressed as a percentage, where 100% indicates a fully charged battery, while 0% indicates a fully discharged (depleted) battery. It is contemplated herein that monitoring the SOC of a battery may provide a better understanding of a battery's capacity and enables estimation with regards to how long a device (e.g., a robot) may operate before requiring recharging.

As used throughout the present disclosure, the term “robot profile” refers to characteristics, features, and/or conditions corresponding to a particular robot. Examples of characteristics, features, and/or conditions forming a robot profile may include, but are not limited to, weight of the robot, energy output by the robot, expected battery life of the robot, battery capacity, battery type, energy consumption model, historical usage data, temperature, charge rate, discharge rate, etc.

As used throughout the present disclosure, the term “electrolyte source” refers to a location and/or container of a medium containing ions so causing the medium to be electrically conducting though the movement of those ions. Accordingly, an electrolyte may include a substance that dissociates in water into ions. Examples of an electrolyte may include, but are not limited to, soluble salts, acids, and bases dissolved in a polar solvent, such as water. Examples of an electrolyte source may include, but are not limited to, a citrus fruit, a salt-rich soil, salt water, etc.

It is contemplated that a citrus fruit combined with a pair of electrodes may be used to construct a basic electrochemical cell. The acidic juice/pulp of the fruit acts as the electrolyte, while a pair of zinc and copper components act as electrodes. Once the electrodes are inserted into the fruit, the fruit may generate a small electrical current through a redox reaction. As a nonlimiting example contemplated herein, a citrus fruit, such as a lemon, may be utilized to perform a chemical reaction to generate electricity. Although the amount of electricity generated electricity may be limited, it is contemplated that the amount of electricity generated may be sufficient to power a power source (e.g., rechargeable battery) of a microbot. To charge a battery using a lemon, the following procedure may be employed. A cathode is inserted a first location on the lemon, and an anode is inserted into a second location on the lemon. Oxidation occurs place in at the anode, while reduction occurs is called the cathode. Accordingly, positive ions, or cations, flow toward the cathode, while negative ions, or anions, flow toward the anode.

Illustrative embodiments include a robot configured to recharge a battery of a robot via a discovered electrolyte source. In an embodiment, the robot is a robotic bee that includes a pair of electrode strings for inserting into an electrolyte source to generate an electrical current from the electrolyte source to charge the battery of the robot. In some such embodiments, the robotic bee may also include a battery management system, a sensor system, a processor, a memory, and a set of instructions stored on the memory that when executed by the processor cause the robotic bee to locate a potential energy source, and utilize the energy source to recharge the battery of the robotic bee. In some embodiments, the robotic bee may include additional devices, such as a pollinator device configured to pollinate a crop.

Illustrative embodiments include locating a potential energy source to sufficient to recharge a robot battery. In some embodiments, the potential energy source includes an electrolyte source. In some such embodiments, the electrolyte source includes a fruit, such as a citrus fruit, including but not limited to, a lemon, a lime, an orange, a grapefruit, etc. It is contemplated herein that a battery of a microbot (e.g., robotic bee) may be in the order of 110-120 milliwatts. It is further contemplated that a grapefruit may generate approximately 1.23 W of power, a lime may generate approximately 0.87 W of power, a lemon may generate approximately 0.91 W of power, and an orange may generate approximately 0.71 W of power. Although some types of fruit are mentioned, it is understood that embodiments are not limited to the utilization of the types of fruit mentioned as an electrolyte source.

Illustrative embodiments further include identifying a potential energy source as a suitable energy source. Identifying a potential electrolyte source as a suitable energy source may includes determining whether the potential energy source meets a predetermined criteria, and upon a determination that the potential energy source meets the predetermined criteria, classifying the potential electrolyte source as a suitable energy source. In an embodiment, the predetermined criteria may be based on a quality indicator and/or characteristics of the potential energy source. As a nonlimiting example, suppose the potential energy source is a citrus fruit, then specific criteria may include the possession certain characteristics that are indicative that the citrus fruit is not suitable for human consumption and/or for being sold as produce. To continue on the previous example, characteristics of a citrus fruit may include, but are not limited to, appearance-based characteristics (e.g., color, shape, size, blemishes, deformities, etc.) as well as freshness-based characteristics, such as the citrus fruit being overripe, rotting, etc. Further, knowledge of whether a particular citrus fruit has previously been utilized as an electrolyte source for recharging a robot may also be taken into consideration for determination of whether the potential energy source is a suitable energy source.

Illustrative embodiments further include constructing and/or optimizing a recharging schedule for a robot based on a set of parameters. The parameters may include, but are not limited to, a work order schedule of a robot, a battery SOC forecast, and/or one or more locations of an identified energy source. Illustrative embodiments further include constructing an optimal flight based on the constructed charging schedule for a robot to follow along during the completion of tasks of a work order schedule.

Illustrative embodiments further include training a first machine learning (ML) model to identify a location of a potential energy source. In some such embodiments, the ML model is trained on satellite image data corresponding to vegetative and non-vegetative land. Further, in some such embodiments, the vegetative land includes vegetative land bearing citrus fruit.

Illustrative embodiments further include training a second machine learning (ML) model identify a suitable energy source within a location of a potential energy source. In some such embodiments, the ML model is trained on image data corresponding to suitable and non-suitable fruit for use in recharging. In an embodiment, suitable fruit includes fruit that meets a certain predetermined criteria based on one or more appearance characteristics, freshness characteristics, and/or past use.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

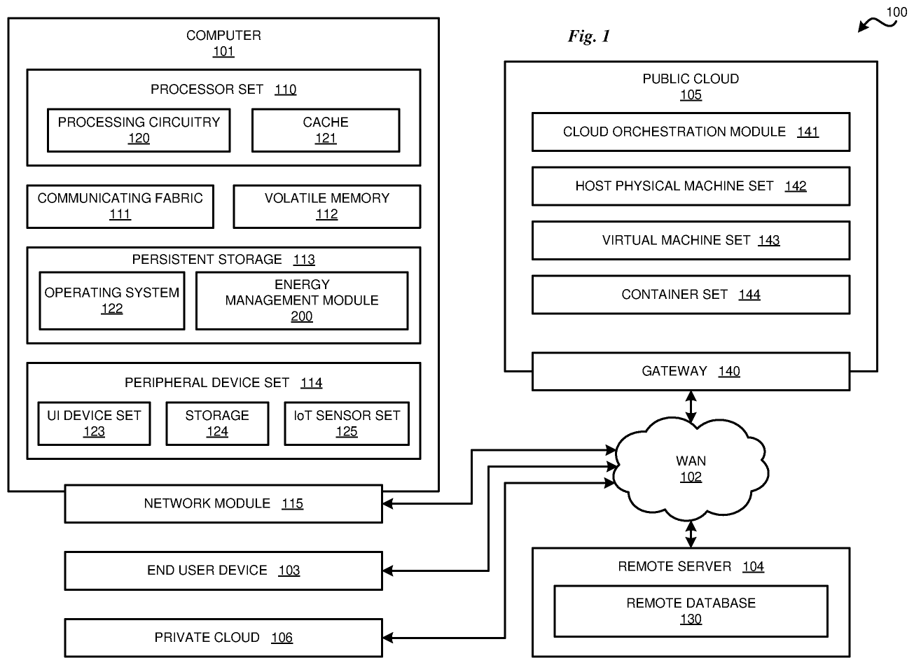

With reference to FIG. 1, this figure depicts a block diagram of a computing environment 100. Computing environment 100 contains an example of an environment for the execution of at least some of the computer code involved in performing the inventive methods, such as an energy management module 200 that monitors a battery of a robot and provides an optimal route for the robot to execute to recharge the robot's battery. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

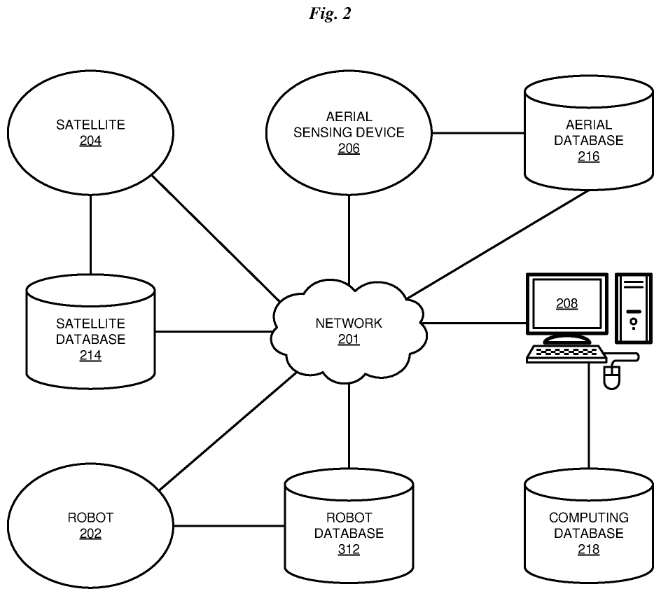

With reference to FIG. 2, this figure depicts a block diagram of an example processing environment of a power management system in accordance with an illustrative embodiment. In the illustrative embodiment, robot 202 includes the energy management module 200 of FIG. 1.

In the illustrated embodiment, the satellite 204 receives satellite data via a sensor system and transmits the satellite data to a satellite image database 214. The satellite 204 may be configured to obtain various data depending on the specific purpose and instrumentation of the satellite 204. Further, the satellite 204 may be equipped with one or more sensors, instruments, communication systems, and/or storage devices that collectively may enable the satellite 204 to obtain, store, and/or transmit data. The satellite 204 may be equipped with a plurality of sensors and other instruments based on the specific purpose and/or data obtained by the satellite 204. An example of sensors and/or instruments that the satellite 204 may be equipped with may include, but are not limited to, a camera, a spectrometer, a radar system, a thermal sensor, etc. Further, the satellite 204 may be equipped with a communication system configured to enable the satellite 204 to transmit data to a ground-based processing facility 208, and/or one or more other satellites (not shown). Further, the satellite 204 may be equipped with an on-board data storage device for storing satellite data on-board the satellite 204, which may enables the satellite 204 to store data until the satellite 204 passes over and/or is in a position to transmit data to a ground-based processing facility 208. Further, the satellite 204 may be apart of a satellite network, which enables data transmission and/or relaying data between satellites. It is contemplated that a satellite network may enable faster data transmission than compared to a single satellite because a satellite network enables transferring data from one satellite to another satellite until the data is transmitted to a ground station, such as ground-based processing facility 208, rather than relying on a single satellite to pass over or otherwise be in a suitable position to transmit data to a ground station.

In an embodiment, the satellite 204 is utilized in part to identify a vegetative landscape via a remote sensing technique. Accordingly, the satellite 204 may be equipped with one or more multispectral and/or hyperspectral sensors for capturing images of the Earth's surface in different bands of the electromagnetic spectrum. These bands may include visible, near-infrared, infrared, microwave, and thermal infrared regions. In an embodiment, satellite 204 is equipped with a microwave sensing device. The microwave sensing device sensor transmits a microwave signal towards one or more targets and detects the backscattered portion of the signal. The strength of the backscattered signal is measured to discriminate between different targets. Since vegetation reflects and absorbs light in distinct ways, the spectral response may be analyzed to identify different types of vegetation. In an embodiment, satellite data is processed in accordance with a vegetation index. For example, the Normalized Difference Vegetation Index (NDVI) compares the reflectance of near-infrared and red light, which enables assessment of the health and density of vegetation. High NDVI values indicate healthy and dense vegetation, while low values can indicate sparse or stressed vegetation. In another embodiment, satellite data is processed in conjunction with one or more classification algorithms, including one or more supervised and/or unsupervised classification algorithms. Accordingly, a classification algorithm uses patterns and statistical analysis to categorize different land cover types, including vegetative landscapes. In an embodiment, the classification algorithm(s) are trained with ground-based data and satellite imagery, to differentiate between various vegetation types and provide detailed vegetation maps. In the illustrative embodiment, robot 202 utilizes satellite data to locate a potential energy source location. In an embodiment, the potential energy source location includes a vegetative landscape that includes citrus fruits.

With continued reference to FIG. 2, an aerial sensing device 206 is shown. Similar to the satellite 204, the aerial sensing device 206 may be equipped with one or more sensors, instruments, communication systems, and/or storage devices that collectively may enable the aerial sensing device to obtain, store, and/or transmit data. The aerial sensing device 206 may be equipped with a plurality of sensors and other instruments based on the specific purpose and/or data obtained by the aerial sensing device 206. In an embodiment, the aerial sensing device 206 is a weather balloon equipped with a radiosonde for measuring pressure, temperature and relative humidity as balloon ascends up into the atmosphere. Accordingly, in an embodiment, the aerial sensing device 206 may obtain weather data and store weather data on the aerial database 216.

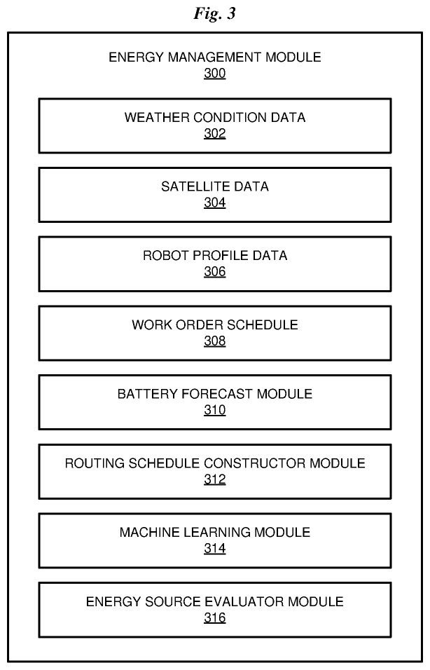

With reference to FIG. 3, this figure depicts a block diagram of an exemplary energy management module 300 in accordance with an illustrative embodiment. In the illustrative embodiment, the energy management module 300 includes the energy management module 200 of FIG. 1.

In the illustrative embodiment, the energy management module 300 includes a weather data storage 302, a satellite data storage 304, a robot profile data storage 306, a work order schedule storage 308, a battery forecast module 310, a routing schedule constructor module 312, a machine learning module 314, and an energy source evaluator module 316. In the illustrative embodiment, the routing schedule constructor module 312 is configured to provide an optimized routing schedule for a robot to follow to recharge an onboard battery of the robot. Accordingly, the routing schedule constructor module 312 may provide an optimized routing schedule based on weather condition data stored on weather condition data storage 302, satellite image data stored on satellite data storage 304, robot profile data stored on robot profile data storage 306, and a work order schedule of the robot stored on work order schedule storage 308. In an embodiment, battery forecast module 310 is configured to predict the available charge of a battery of the robot during a period of operation over time, based in part on robot profile, weather condition data, and/or a work order schedule of a robot. In an embodiment, the routing schedule constructor module 312 may provide an optimized routing schedule based on the battery forecast provided by the battery forecast module 310 and an energy source location that may be obtained based in part on satellite image data. In an embodiment, energy source evaluator module 316 may be configured to evaluate a particular node corresponding to a potential energy source as a suitable energy source for recharging the battery of the robot. In the illustrative embodiment, machine learning module 314 is configured to construct and/or train one or more machine learning (ML) models to perform one or more tasks as described herein, including but not limited to, locating a potential energy source location, evaluating a suitable energy source, and/or optimizing a routing schedule.

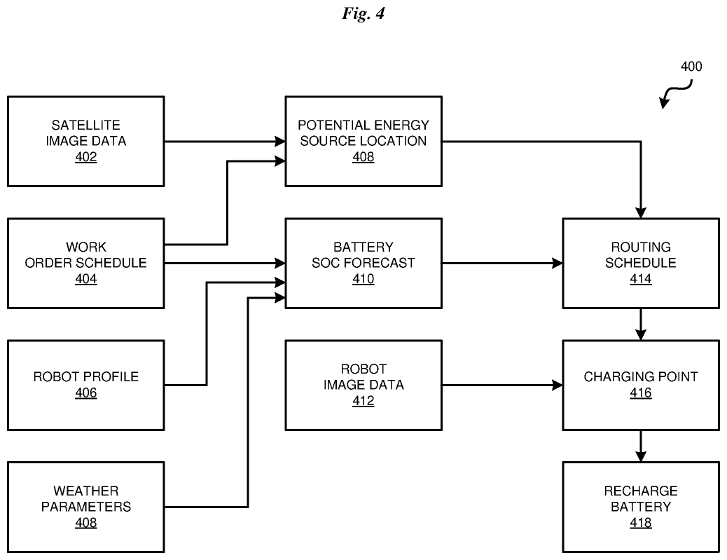

With reference to FIG. 4, this figure depicts a block diagram of an example energy management process 400 in accordance with an illustrative embodiment. In the illustrative embodiment, a potential energy source location 408 is located based in part on satellite image data 302 and/or a work order schedule 404 corresponding to a robot, such as a robotic bee as described herein. The satellite image data 402 may include any data obtained and/or processed by a satellite, as described in greater detail herein.

Further, in the illustrative embodiment, a battery state of charge (SOC) forecast 410 is determined based at least in part on a work order schedule 404, a robot profile 406, and/or one or more weather parameters 408. The robot profile 404 may include characteristics pertaining to a particular robot. As a nonlimiting limiting example, the robot profile 404 may include, but is not limited to, weight of the robot, energy output by the robot, expected battery life of the robot, battery capacity, battery type, energy consumption model, historical usage data, temperature, charge rate, discharge rate, etc. The robot profile 404 may also include characteristics related to the electrodes of the robot, including characteristics corresponding to the anode, and characteristics corresponding to the cathode. In an embodiment, determining a battery SOC forecast 310 includes utilizing one or more machine learning models to construct a predictive ML model for estimating a robot battery SOC more accurately and efficiently.

The weather parameters 408 may include, but are not limited to, weather condition (e.g., rain, snow, etc.), temperature, humidity, wind speed, wind direction, precipitation, atmospheric pressure, visibility, cloud cover, dew point, and/or air quality. It is contemplated herein that weather parameters may influence the battery SOC, and thereby may affect the predicted battery SOC forecast 310. In some embodiments, weather parameter data is obtained via one or more sensors communicatively coupled to a robot. For example, the robot may include a sensor system, wherein the sensor system may include one or more sensors, a processor, and a memory storage, and be configured to collect, process, and/or transmit sensor data received via the one or more sensors. The one or more sensors may include, but are not limited to, a visual sensor (e.g., a camera) a temperature sensor (e.g., thermometer), a humidity sensor, a rain sensor, a wind speed sensor, a vibration sensor, a proximity sensor, a position sensor, a motion detector, a photoelectric sensor, an infrared sensor, an ultrasonic sensor, a microwave sensor, a pressure sensor, an accelerometer, a gyroscope, a current sensor, voltage sensor, and/or any combination thereof. Further, the sensor system may include a processor, a memory, and instructions stored on the memory that when actuated by the processor cause the sensor system to obtain, process, and/or transmit sensor data to a plurality of locations, including but not limited to, an on-board sensor data storage, a remote sensor data storage location, and or sensor data storage of another robot.

With continued reference to FIG. 4, a routing schedule 414 may be constructed for battery recharging across a set of potential docking nodes representing potential energy sources, based in part on battery forecast 410 and a potential energy source location 408 that has been located based in part on satellite image data 402. With continued reference to FIG. 4, the process 400 identifies a charging point 416 (e.g., suitable energy source) based upon robot image data 412 and in consideration of the routing schedule 414 assigned to the robot. Accordingly, once the robot arrives at a potential energy source location 408, the robot scans the potential energy source location 408 for a potential energy source. Upon detection of a potential energy source, the process 400 evaluates whether the potential energy source is a suitable energy source, based in part on a predetermined suitability criteria. The process causes the robot to obtain visual data corresponding to the potential energy source and processes the visual information determine whether the visual data is indicative of a suitable energy source, i.e., charging point 416. Upon an evaluation that the potential energy source may constitute a charging point 416, the process causes the robot to insert a pair of electrodes into the charging point 416 to recharge the onboard battery of the robot, as depicted by block 418.

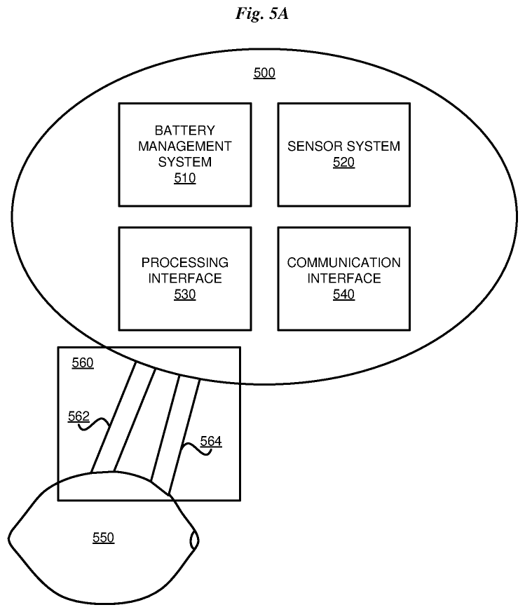

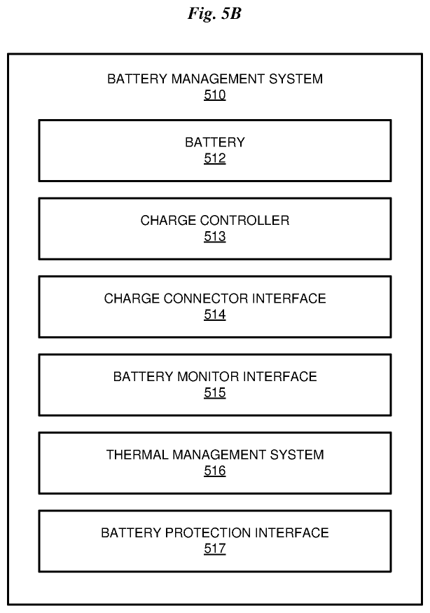

With reference to FIG. 5A, this figure depicts a block diagram of a microbot 500. In the illustrated embodiment, the microbot 500 is an example of robot 202 of FIG. 2.

In the illustrative embodiment, the microbot 500 includes a battery management system 510, a sensor system 520, a processing interface 530, and a communication interface 540. In the illustrative embodiment, the microbot also includes a pair of electrodes 560 coupled to the battery management system 510 that enable the microbot 500 to charge an onboard battery of the microbot 500 from a suitable energy source. The battery management system 510 is configured to manage a battery charge level of a battery within microbot 510, as described in greater detail herein. The sensor system 520 includes one or more sensors for obtaining sensor data corresponding to an external environment and/or within microbot 500.

In the illustrated embodiment, the processing interface 530 includes a processor, a memory, and a set of instructions stored on the memory that when executed by the processor, cause the processing interface 530 to perform one or more tasks. The one or more tasks performed by the processing interface 530 may include, but are not limited to, tasks related to the operation of the microbot 500, tasks related to the functioning of the battery system 510, tasks related to processing sensor data obtained by the sensor system 520, and/or tasks related to communicating information via the communication interface 540. In an embodiment, the processing interface 530 enables the microbot 500 to travel to one or more potential energy source locations. In an embodiment, the processing interface 530 enables the microbot 500 to evaluate whether a potential energy source meets a predetermined suitability criteria, and upon an evaluation that the potential energy source meets the predetermined suitability criteria, classifies the potential energy source as a suitable energy source. In an embodiment, the processing interface 530 enables the microbot 500 to insert the pair of electrodes 560 into a suitable energy source to generate electricity from the suitable energy source to power an onboard battery of the microbot 500. The communication interface 540 may transmit information between the microbot 500 and a remote processing destination, a network environment, a cloud storage environment, and/or between other robots (not shown). In an embodiment, the communication interface transmits location data corresponding to a location of a previously identified suitable energy source.

In the illustrative embodiment, the microbot 500 is configured to recharge an onboard rechargeable battery from an electrolyte source 550 via a pair of electrodes 560. In the illustrative embodiment, the pair of electrodes includes a cathode 562 and an anode 564. As a nonlimiting example contemplated herein, suppose the electrolyte source 550 is a citrus fruit, in which case inserting the cathode 562 and the anode 564 into the electrolyte source 550 causes an electrical current to be generated. Accordingly, it is contemplated herein that a citrus fruit contains a citric acid containing solution (e.g., juice). When the cathode 562 and the anode 564 are inserted into the electrolyte source 550, the cathode 562 and anode 564 come into contact with citric acid, causing ions to move within the citric acid containing solution. It is contemplated herein that electrical current may be generated via a reduction-oxidation (“redox”) reaction that occurs at the electrodes 560. Accordingly, oxidation occurs at the anode 564, in which the anode 564 loses electrons and forms positively charged ions. As a nonlimiting example, if the anode 564 is made of zinc, then the zinc oxidizes to form zinc ions (Zn²⁺). Further, reduction occurs at the cathode 562, in which the cathode 562 gains electrons and forms negatively charged ions. As a nonlimiting example, if the cathode 562 is made of copper, then the copper reduces and forms copper ions (Cu²⁺). Electrons flow from the anode 564 to the cathode 562 through a circuit connected to the battery management system 510 disposed within the microbot 500, thereby causing an electrical current to be generated and transmitted to an onboard rechargeable battery of the microbot 500. Accordingly, as the oxidation and reduction reactions occur at the electrodes 560, ions from the electrolyte (e.g., citric acid) move towards the respective electrode to maintain charge balance. Positively charged ions (such as hydrogen ions, H⁺) move toward the cathode 562, and negatively charged ions (such as sulfate ions, SO₄²⁻) move toward the anode 564. In the illustrative embodiment, the circuit of microbot 500 completes by connecting the electrodes 560 to the battery management system 510. Electrical current flows through the battery management system 510, causing a battery of the microbot 500 to recharge.

With reference to FIG. 5B, this figure depicts a block diagram of an example battery management system 510. In the illustrative embodiment, the battery management system 510 may include a battery 512, a charge controller 513, a charge connector interface 514, a battery monitor interface 515, a thermal management system 516, and a battery protection interface 517. In the illustrative embodiment, the battery management system 510 is configured to enable the battery 512 to recharge from an energy source. In an embodiment, the energy source includes the electrolyte source 550 of FIG. 5A, wherein connecting the pair of electrodes 560 to the electrolyte source 550 effectively configures the electrolyte source as a source battery. In an embodiment, upon inserting the electrodes 560 into the electrolyte source 550, a battery charging circuit is completed that connects the positive terminal of the source battery (i.e., anode 564) to a positive terminal of the battery 512 and connects the negative terminal of the source battery (i.e., cathode 562) to a negative terminal of the battery 512. In the illustrative embodiment, the charge connector interface 514 connects the battery 512 to the pair of electrodes inserted into the electrolyte source 550 via wires or any other suitable connection means.

In the illustrative embodiment, the charge controller 513 may regulate the charging process of battery 512. In an embodiment, the charge controller 513 includes a voltage multiplier circuit for increasing the voltage received by the battery 512 from the source battery. Accordingly, a voltage multiplier is an electronic circuit that may include a combination of capacitors and diodes to step up the voltage from the source battery. The voltage multiplier circuit may work in stages to charge and discharge capacitors through a series of diodes, wherein the output of each stage is the input for each subsequent stage, in so that each stage may increase the input voltage. For example, a voltage doubler circuit may include two capacitors and two diodes. When input voltage is applied, the first capacitor charges up to the input voltage level, and the second capacitor charges in series with the first capacitor. The diodes enable the voltage across the second capacitor to be additive, thereby doubling the input voltage. It is contemplated that higher voltage multiplication may be achieved by including more stages of capacitors and diodes. For example, a voltage tripler circuit includes three stages, and each stage adds the voltage across an additional capacitor, thereby resulting in a tripled output voltage. It is contemplated herein that the voltage multiplier circuit may be configured to include any number of stages to provide a suitable voltage for the battery 512.

In the illustrative embodiment, the thermal management system 516 monitors the temperature of the battery 512 and regulates the battery temperature if the battery temperature falls outside of a safe operating limit and/or optimal operating range. If the temperature rises too high, the thermal management system 516 may activate one or more cooling mechanisms to reduce the temperature of the battery. If the temperature falls too low, the thermal management system 516 may activate one or more heating mechanisms to increase the temperature of the battery. In an embodiment, the thermal management system 516 is configured to dissipate excess heat generated during charging and/or discharging. In some embodiments, heat dissipation may be achieved using a liquid cooling mechanism, an air cooling mechanism, or some combination thereof. It is contemplated that heat dissipation helps to maintain the battery 512 at an optimal temperature range, preventing overheating and potential damage to the battery. In an embodiment, the thermal management system 516 is configured to preheat the battery via a heating mechanism and/or adjust a cooling mechanism to optimize battery performance if the battery temperature is below a lower limit of an optimal temperature range. The exact optimal temperature range for a battery may be based upon the specific battery utilized, and will be apparent to one having ordinary skill in the art. In an embodiment, the thermal management system 516 may include a temperature sensor coupled to the battery 512 to measure the temperature of the battery 512, and upon detection that the measured temperature exceeds an optimal range, the thermal management system 516 activates a cooling or hearting mechanism, and/or causes the battery management system 510 to cease charging the battery 512.

In the illustrative embodiment, the battery protection interface 517 monitors the battery 512 to protect against overcharging, over-discharging, and/or excessive current. In an embodiment, the battery protection interface 517 includes a voltage sensor for monitoring the voltage of the battery 512. When the battery voltage reaches a predetermined upper limit, such as the maximum safe voltage based on the battery chemistry, the battery protection interface 517 may interrupt charging to prevent overcharging. If the battery voltage drops below a set lower limit, such as the minimum safe voltage, the battery protection interface 517 disconnects the battery 512 to prevent over-discharging. In an embodiment, the battery protection interface 517 includes a current sensor for monitoring the current flowing into and out of the battery 512. If the current exceeds a safe threshold, the battery protection interface 517 may open a safety switch to disconnect the battery from the charging source, preventing damage to the battery and the microbot 500.

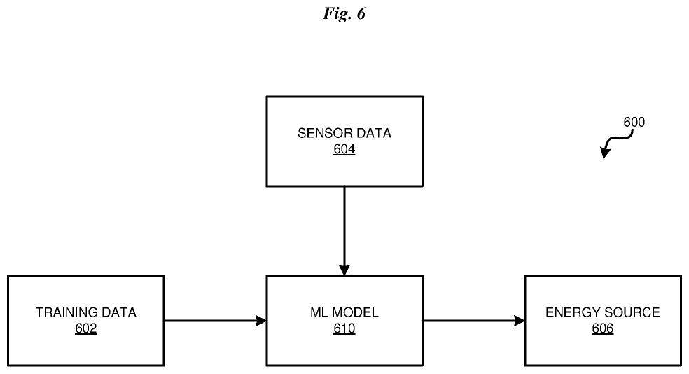

With reference to FIG. 6, this figure depicts a block diagram of an exemplary process for identifying a potential energy source. In the illustrative embodiment, a machine learning (“ML”) model 610 is trained on training data 602 to recognize a potential energy source within a potential energy source location. Once ML model 610 has been trained on a training dataset 602, the ML model 610 may recognize an energy source 606 based on sensor data 604 received via one or more sensors of a sensor system.

In another embodiment, ML model 610 is trained to identify a vegetative environment containing citrus fruits. Accordingly, the ML model 610 may likewise be trained to identify vegetative land that includes potential energy sources, such as citrus fruits. In an embodiment, the process 600 trains the ML model 610 in the following exemplary manner. The process 600 collects a dataset 602 of satellite images, wherein the training dataset includes satellite images of vegetative land and non-vegetative land. In an embodiment, the images of vegetative land are labeled as images of vegetative land, while the images of non-vegetative land are labeled as images of non-vegetative land. In an embodiment, the process utilizes one or more pre-processing techniques for pre-processing the satellite images to provide consistency and/or remove noise or other irrelevant information. The one or more pre-processing techniques may include a resizing technique, a data augmentation technique, and/or a data augmentation technique. In an embodiment, the process 600 extracts relevant features from the satellite images that may be indicative of vegetative land. In some such embodiments, features are extracted using a convolutional neural network (“CNN”). In some embodiments, the process 600 trains the ML model 610 to identify a salt-rich soil environment. In some embodiments, the process 600 trains the ML model 610 to identify salt-water containing environments.

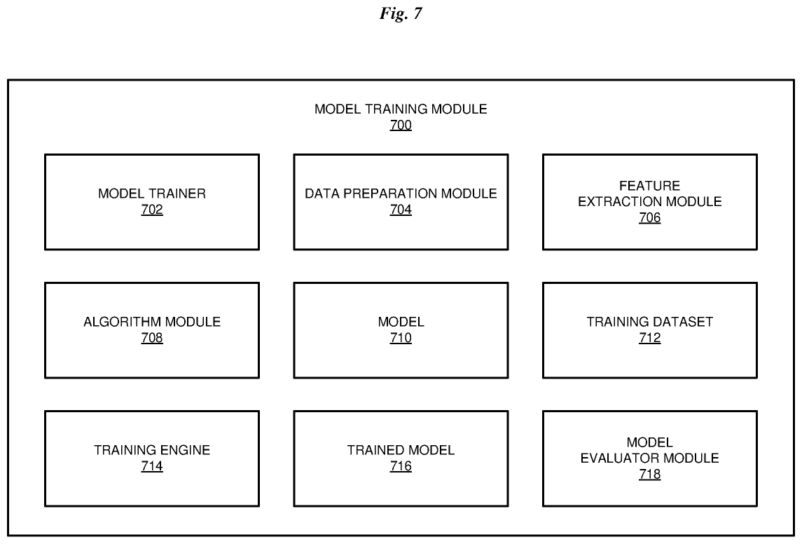

With reference to FIG. 7, this figure depicts a block diagram of an exemplary model training module 700 in accordance with an illustrative embodiment. In the illustrated embodiment, model training module 700 includes a model trainer 702. The model trainer 702 includes a data preparation module 704, a feature extraction module 706, an algorithm module 708, a training engine 714, and machine learning model 710. In alternative embodiments, the model training module 700 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In some embodiments, the model trainer 702 generates a machine learning model 710 based on an algorithm provided by algorithm module 706. In an embodiment, the algorithm module 708 selects the algorithm based on one or more known machine learning algorithms. In an embodiment, model trainer 702 includes a training engine 714 that trains the machine learning model 710 using the training dataset 712. In some embodiments, the training dataset 712 includes image data corresponding to electrolyte sources, for training a CNN to recognize a suitable energy source for use in recharging an onboard battery of a robot.

In some embodiments, the training dataset 712 is pre-processed by a data preparation module 704 for the model trainer 702. In some such embodiments, the data preparation module 704 structures the data to make best use of the machine learning model 710. Embodiments of the data preparation module 704 use one or more of the following heuristics:
Linear data transformation: transform the data to make the relationship linear (e.g., log transform for an exponential relationship);
Noise reduction: use data cleaning operations that better expose and clarify the signal in the data, e.g., remove outliers in the output variable (y) where possible;
Collinearity reduction: calculate pairwise correlations for the input data and remove the most correlated to prevent over-fitting of the data due to highly correlated input variables;
Gaussian distribution: transform the input data (e.g., logarithmic or Box-Cox transformation) so that input and output variables have a Gaussian distribution; and
Rescale Inputs: scale data using normalization (e.g., rescale data so that values are within a range of 0 and 1) or standardization (e.g., rescale data so that the mean of observed values is 0 and the standard deviation is 1).

In an embodiment, the training engine 714 trains the machine learning model 710 using the training dataset 712, resulting in the trained machine learning model 716. In some embodiments, the training dataset 712 is divided into two discrete subsets, where one subset is used by the training engine 714 for initially training the machine learning model 710. The other subset is used by the training engine 714 to test the trained model 714 and determine the accuracy of the trained model 714. In an embodiment, model evaluator module 718 evaluates the performance of the trained model 716.

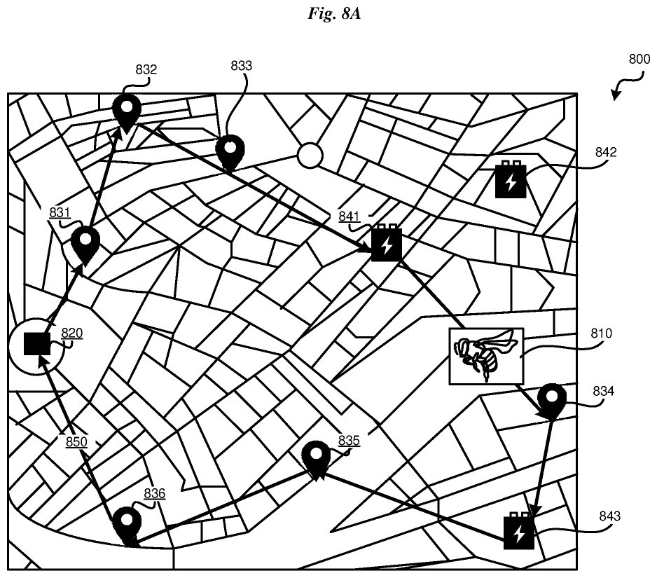

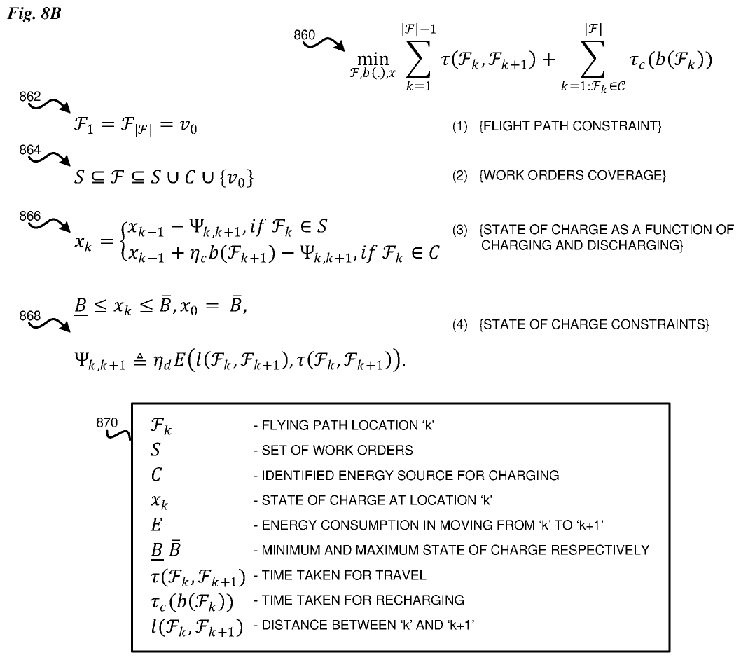

With reference to FIG. 8A, this figure depicts a graph representing an optimal route schedule for recharging robot. In an embodiment, the robot is a miniature aerial vehicle, such as a robotic bee. Embodiments disclosed herein include constructing the graph 800 and determining an optimal flight path for a robotic bee to undertake based at least in part on a battery SOC forecast, locations of worker order tasks, and locations of identified energy sources. In the illustrative embodiment, nodes of the graph represent a departure point 820, a plurality of work order task locations 831-836 and identified energy source locations 841-843. Further, the collection the edges between each node of the graph 800 represent the flight path 850 for a robotic bee. As depicted in the FIG. 8A, there is a single departure point 820 from which the robotic bee 810 may depart from and ultimately may return to. Starting from the departure point 820, the robotic bee 810 travels to each node of the graph, until the robotic bee return to the departure point 820. In the illustrated embodiment, the work order schedule includes six work order task locations 831-836. Each work order task location represents a location at which the robotic bee 810 may perform a task. In order to accomplish more work order tasks, the robotic bee 810 may be able to recharge the robotic bee's battery along the course of completing the work order tasks. Each identified charging source location 841-843 represents a location where it may be possible for the robotic bee 810 to recharge its battery. The optimal flight path 850 to be undertaken by the robotic bee 810 may be determined in consideration of a battery SOC forecast, the work order schedule, and one or more locations of identified energy sources usable for recharging the robotic bee's battery.

With continued reference to FIG. 8A, a first identified energy source location 841 is shown existing between a third work order task location 833 and a fourth work order task location 834. In accordance with the scenario depicted by FIG. 8A, it may be optimal for the robotic bee 810 to recharge its battery at the first identified energy source location 841 upon completion of the work order task(s) at the third work order task location 833 and prior to performing the work order tasks(s) at the fourth work order task location 834. Although a second identified energy source location 842 exists, the robotic bee 810 does not recharge at the second identified energy source location 842, because the second identified energy source location 842 does not conform to the calculated optimal flight path 850 depicted by graph 800. Further, in accordance with the scenario depicted by FIG. 8A, it may be optimal for the robotic bee 810 to recharge its battery at the third identified energy source location 843 upon completion of the work order task(s) at the fourth work order task location 834 and prior to performing the work order tasks(s) at the fifth work order task location 835. In the illustrative embodiment, the battery SOC forecast corresponding to the battery of the robotic bee 810 indicates that the robotic bee 810 may benefit from recharging its battery upon completion of the task(s) at the third work order task location 833 and upon completion of the work order task(s) at the fourth work order task location 834.

With reference to FIG. 8B, this figure depicts a framework for optimized route planning. In the illustrative embodiment, the framework may include a mathematical framework including one or more formulas defining an optimized route. Accordingly, the framework for providing an optimized route may consider a number of known factors including, but not limited to, work order schedule, battery capacity, and/or identified energy source recharging nodes, in order to minimize traveling time as well as recharging time for a particular robotic bee. In the illustrative embodiment, the framework includes formula 860 which may include two components as shown, including a first component that minimizes the flying time between nodes, and a second component that minimizes recharging time. Further, in an embodiment, formula 860 may be subjected to a number of constraints. In the illustrative embodiment, the formula 860 includes a first constraint 862 representing a flight path constraint, wherein the first constraint 862 may ensure that the start point and end point of a route are known. Also, the formula 860 may include a second constraint 864, representing a work order coverage constraint, wherein the second constraint 864 may ensure that all work order tasks are completed by the robotic bee. Also, the formula 860 may be include a third constraint 866, wherein the state of charge is defined as a function of charging and discharging. Also, the formula 860 may include a fourth constraint 868, wherein the fourth constraint defines state of charge constraints. With continued reference to FIG. 8B, the illustrative embodiment includes a reference table 870, wherein the table 870 defines variables used in formula 860 as well as the first constraint 862, the second constraint 864, the third constraint 866, and the fourth constraint 868.

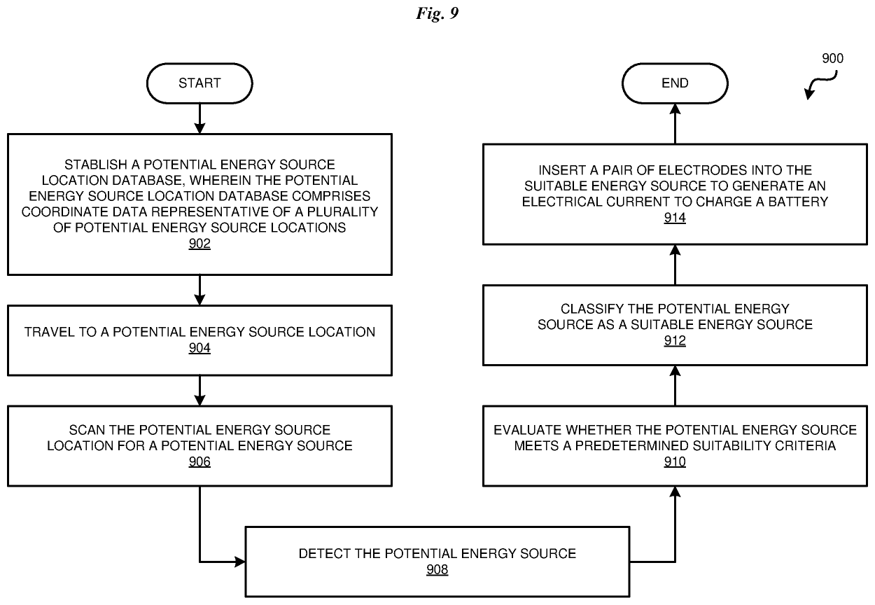

With reference to FIG. 9, this figure depicts a flowchart of an example process for autonomous robot power management in accordance with an illustrative embodiment. In an embodiment, energy management module 200 of FIG. 1 and/or energy management module 300 of FIG. 3 carries out process 900.

At block 902, the process 900 establishes a potential energy source location database that comprises coordinate data representative of a plurality of potential energy source locations. In an embodiment, one or more potential energy source locations are obtained via one or more satellite imaging techniques. For example, multi-spectral, hyperspectral, and microwave data may be obtained from a satellite indicative of a vegetative environment. Further, satellite data may be processed to identify specific vegetative environments, such as a vegetative environment that includes citrus fruits. In an embodiment, satellite data may be processed to identify other types of potential energy source locations, including but not limited to, a location corresponding to salt-rich soil, and a location corresponding to salt-water.

At block 904, the process causes a robot to travel to a potential energy source location. In an embodiment, the process causes the robot to travel to specific coordinates that correspond to a potential energy source location. Accordingly, the potential energy source location database may comprise exact coordinates corresponding to one or more potential energy source locations.

At block 906, the process causes a robot to scan the potential energy source location for a potential energy source. Examples of potential energy sources may include, but are not limited to, citrus fruit, salt-rich soil, and/or salt-water. At block 908, the process detects a potential energy source in the potential energy source location.

At block 910, the process evaluates whether the potential energy source meets a predetermined suitability criteria. In some embodiments, the predetermined suitability criteria is based at least in part on a set of appearance-based characteristics. Upon an evaluation that the potential energy source meets the predetermined suitability criteria, the process continues to block 912, where the process classifies the potential energy source as a suitable energy source. At block 914, the process causes the robot to insert a pair of electrodes into the suitable energy source to generate an electrical current to charge an onboard battery of the robot.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A robotic system comprising:
a sensor system;
a battery;
a pair of electrodes coupled to the battery; and
a processor, a memory, and a set of instructions stored on the memory that when executed by the processor cause the robotic system to:
travel to a potential energy source location,
scan the potential energy source location for a potential energy source via the sensor system;
detect the potential energy source in the potential energy source location;
evaluate whether the potential energy source detected meets a predetermined suitability criteria;
upon an evaluation that the potential energy source meets the predetermined suitability criteria, classify the potential energy source as a suitable energy source; and
insert the pair of electrodes into the suitable energy source to generate an electrical current to charge the battery.

2. The robotic system of claim 1, wherein the potential energy source location is obtained based at least upon satellite data corresponding to a vegetative landscape.

3. The robotic system of claim 1, wherein the sensor system comprises a camera configured to obtain image data from the potential energy source location to process to detect the potential energy source.

4. The robotic system of claim 1, wherein the predetermined suitability criteria is based at least in part on a set of appearance-based characteristics.

5. The robotic system of claim 1, wherein the robotic system comprises a micro-aerial vehicle.

6. The robotic system of claim 1, wherein the set of instructions stored on the memory that when executed by the processor further cause the robotic system to travel to a location of a previously identified suitable energy source.

7. The robotic system of claim 1, wherein the set of instructions stored on the memory that when executed by the processor further cause the robotic system to travel along an optimal flight path.

8. The robotic system of claim 7, wherein the optimal flight path is constructed based on a state of charge forecast of the battery, a work order schedule assigned to the robotic system, and a plurality of potential energy source locations.

9. The robotic system of claim 8, wherein the state of charge forecast is predicted based on the work order schedule assigned to the robotic system, a profile of the robotic system, and a set of weather parameters.

10. A computer program product comprising one or more computer readable storage media, and program instructions collectively stored on the one or more computer readable storage media, the program instructions executable by a processor to cause the processor to perform operations comprising:
establishing a potential energy source database based at least in part on sensor data received from a satellite, wherein the potential energy source database comprises coordinate data representative of a plurality of potential energy source locations;
instructing a robot to travel to a potential energy source location of the plurality of potential energy source locations;
scanning the potential energy source location for a potential energy source;
detecting the potential energy source in the potential energy source location;
evaluating whether the potential energy source meets a predetermined suitability criteria;
upon an evaluation that the potential energy source meets the predetermined suitability criteria, classifying the potential energy source as a suitable energy source; and
instructing the robot to insert a pair of electrodes into the suitable energy source to generate an electrical current to charge a battery of the robot.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

13. The computer program product of claim 10, further comprising instructing the robot to travel along an optimal flight path.

14. The computer program product of claim 13, further comprising constructing the optimal flight path based at least in part on a state of charge forecast of the battery, a work order schedule of the robot, and a set of weather parameters.

15. The computer program product of claim 10, further comprising instructing the robot to travel to a location of a previously identified suitable energy source.

16. The computer program product of claim 10, wherein the predetermined suitability criteria are based at least in part on a set of appearance-based characteristics.

17. A computer system comprising a processor and one or more computer readable storage media, and program instructions collectively stored on the one or more computer readable storage media, the program instructions executable by the processor to cause the processor to perform operations comprising:
establishing a potential energy source database based at least in part on sensor data received from a satellite, wherein the potential energy source database comprises coordinate data representative of a plurality of potential energy source locations;
instructing a robot to traveling to a potential energy source location of the plurality of potential energy source locations;
detecting the potential energy source in the potential energy source location;
evaluating whether the potential energy source meets a predetermined suitability criteria;
upon an evaluation that the potential energy source meets the predetermined suitability criteria, classifying the potential energy source as a suitable energy source; and
instructing the robot to insert a pair of electrodes into the suitable energy source to generate an electrical current to charge a battery of the robot.

18. The computer system of claim 17, further comprising instructing the robot to travel along a predetermined optimal route schedule.

19. The computer system of claim 18, wherein the predetermined optimal route schedule is constructed based at least in part on a state of charge forecast of a battery of the robot, a work schedule assigned to the robot, and a set of weather parameters.

20. The computer system of claim 17, wherein the predetermined suitability criteria are based at least in part on appearance-based characteristics.
